(19) United States
(12) Patent Application Publication
(10) Pub. No.: US 2012/0326878 A1
(43) Pub. Date: Dec. 27, 2012

(54) DEVICE CAPABLE OF INDICATING THAT AT LEAST ONE TEMPERATURE THRESHOLD HAS BEEN REACHED AND/OR EXCEEDED

(76) Inventors: Jean Pierre Viguie, Courbepine (FR); Olivier Rayant, Blain (FR)

(21) Appl. No.: 13/511,575

(22) PCT Filed: Nov. 25, 2009
(86) PCT No.: PCT/FR2009/052297

§ 371 Date: Sep. 11, 2012

(30) Foreign Application Priority Data
Nov. 26, 2008 (FR) 0806679
Nov. 26, 2008 (FR) 0806680

(51) Int. Cl. G08B 21/18

(52) U.S. Cl. 340/584

(57) ABSTRACT

The invention relates to a device capable of indicating that at least one temperature threshold has been reached and/or exceeded, characterized in that the device includes a substrate (1), at least one of the surfaces of which comprises at least one externally visible visual and/or audio indicator (2), said substrate (1) including: at least one component (6′) capable of changing form and/or size when exposed to temperature, said changes that are carried out when said at least one temperature threshold is reached or exceeded causing the movement of said component (6′); at least one transmission or communication means (8) that enables the direct or indirect transmission of said movement of the component (6′) to and/or towards the visual and/or audio indicator (2), said transmission being expressed as: a change in the appearance of the indicator (2) if the latter is visual; and/or a release of an audio signal if the indicator (2) is an audio one.

The present invention relates to a device capable of indicating that at least one temperature threshold has been reached and/or exceeded. It relates notably, but not exclusively, to a device which allows an operator to take visual note that the temperature of the product including said device has reached or exceeded a determined threshold.

It is known that the implementation of a cold chain is intended to maintain food products or pharmaceutical products at a given temperature, or below a given temperature, in order to preserve the qualities and properties of said products. It is also known that a break in the cold chain causes a development of pathogenic germs and/or deterioration in said products which may, in this latter case, result in the reduction or suppression of the therapeutic effect of the latter if they involve medicinal products.

In order to prevent breaks in the cold chain, the following are traditionally used:
temperature recorders which generally comprise a temperature sensor, an electronic memory, a microcontroller, and a battery; thus, these recorders have the disadvantage of having a complex structure which increases the purchase cost of the assembly and does not allow them to be incorporated directly into the products of which the temperature is to be monitored; and/or
insulated bags whose walls comprise heat insulators which allow heat exchanges to be slowed down or suppressed; however, these bags can only be used in specific instances, notably during transport operations, and do not allow the temperature of the products which they contain to be indicated.

The object of the invention is therefore, more particularly, to solve this problem by proposing a device capable of indicating that least one temperature threshold has been reached and/or exceeded, this device having a structure simple enough to allow it to be included or disposed on the product of which the temperature is to be monitored.

For this purpose, the invention proposes a device capable of indicating that at least one temperature threshold has been reached and/or exceeded, characterized in that it includes a substrate, at least one of the surfaces of which comprises at least one externally visible visual and/or audio indicator, said substrate including:
at least one component capable of changing form and/or size under the influence of temperature; these changes that take place when said at least one temperature threshold is reached or exceeded causing a movement of said component;
at least one transmission or communication means that enables the direct or indirect transmission of said movement of the component to and/or toward the visual and/or audio indicator, said transmission being expressed as:
   a change in the appearance of the indicator if the latter is visual; and/or
   a release of an audio signal if the indicator is an audio indicator.

According to one embodiment of the invention, the component capable of changing size may comprise a rod or bar made from a material having the characteristic of expanding when the ambient temperature reaches or exceeds said temperature threshold. Thus, the expansion of this material is expressed as a translation movement of said component which is transmitted by the transmission means to at least one visual indicator which in turn undergoes a translation movement. This translation movement of the visual indicator advantageously allows the presentation of visual information indicating that said temperature threshold has been reached or exceeded.

According to a different embodiment of the invention, the component capable of changing form may comprise a solid having the characteristic of liquefying when the ambient temperature reaches or exceeds said temperature threshold. Thus, the liquefaction of the component is expressed as a flow movement of the latter into a communication means which directs this liquid toward said visual indicator. The impregnation of at least part of this visual indicator and an absorbent layer in contact with this indicator, following this flow, is expressed as a modification of the appearance of the indicator, indicating that said temperature threshold has been reached or exceeded.

In this way, and in an advantageous manner, the device according to the invention, due to the simplicity of its structure, can be included in or fixed directly to the product of which the temperature is to be monitored, while allowing simple determination of whether this temperature has reached or exceeded a determined threshold.

One embodiment of the invention will be described below, by way of a nonlimiting example, with reference to the appended drawings, in which:

FIG. 1 is a schematic representation of the visible surface of the substrate of the device according to one embodiment of the invention.

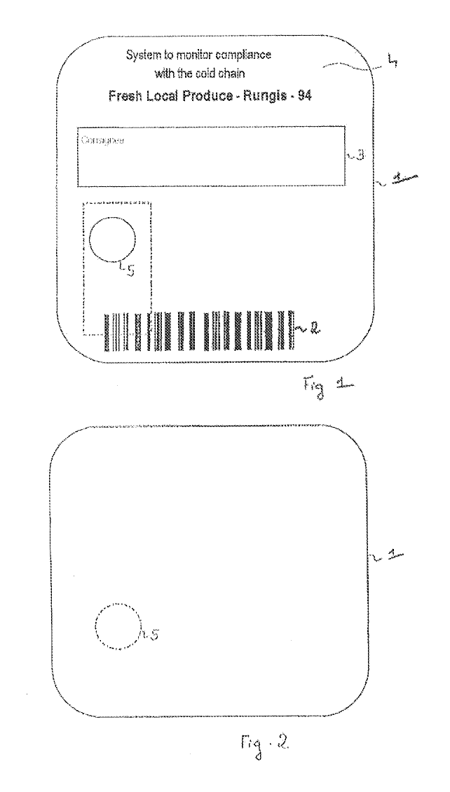

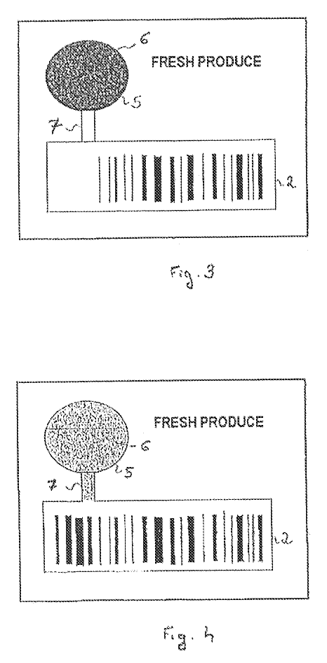

FIG. 2 is a schematic representation of the lower surface of the substrate of the device according to this embodiment of the invention.

FIG. 3 is a schematic representation, according to a longitudinal section, of a part of the visible surface of the substrate, as shown in FIG. 1, notably showing the visual indicator and a reservoir of a component capable of changing form.

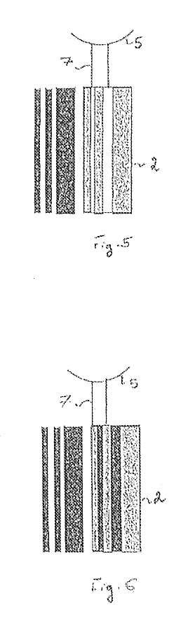

FIG. 4 is a schematic representation of the part of the visible surface of the substrate, as shown in FIG. 3, after the temperature threshold has been reached or exceeded.

FIG. 5 is a close-up view of the visual indicator of said reservoir and communication means of the device as shown in FIG. 3.

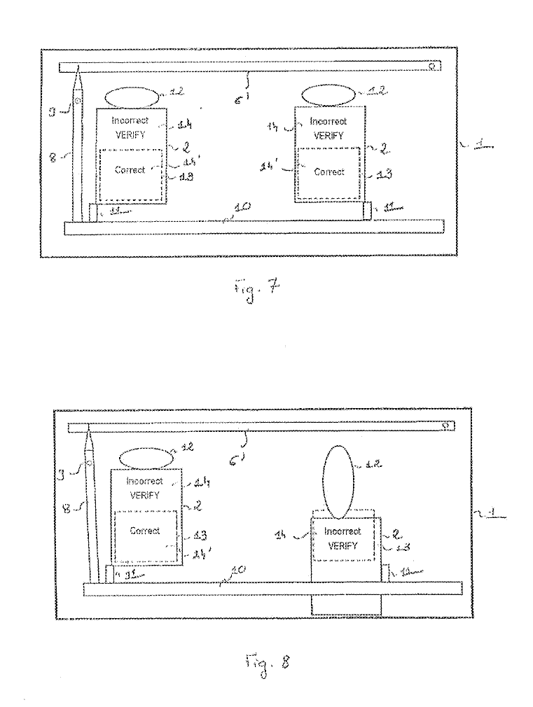

FIG. 6 is a schematic representation of the part of the device according to this embodiment of the invention, shown in FIG. 3, after the temperature threshold has been reached or exceeded.

FIG. 7 is a schematic representation, according to a longitudinal section, of the substrate of the device according to one embodiment of the invention, this substrate comprising a component capable of changing size according to temperature.

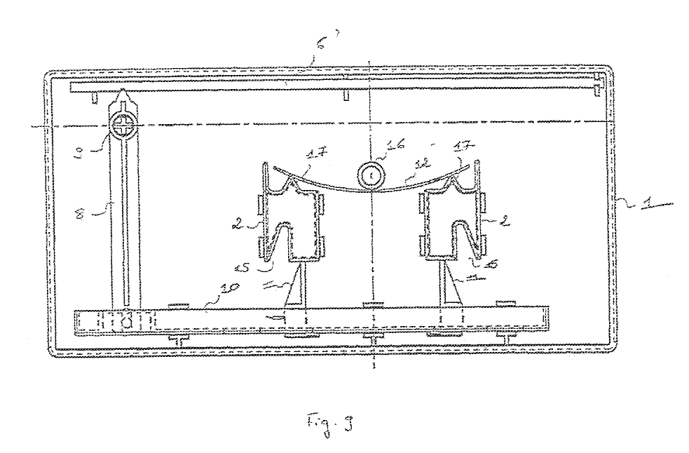

FIG. 8 is a schematic representation, according to a longitudinal section, of the substrate as shown in FIG. 7, after the temperature threshold has been reached or exceeded.

FIG. 9 is a schematic representation, according to a longitudinal section, of the substrate of the device according to a different embodiment of the invention, this substrate comprising a component capable of changing size according to the temperature.

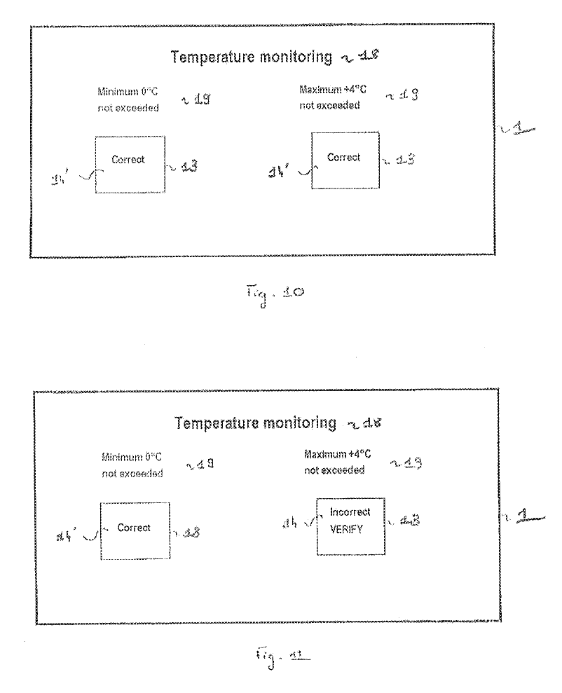

FIG. 10 is a schematic representation of the visible surface of the substrate shown in FIGS. 7 to 9.

FIG. 11 is a schematic representation of the visible surface of the substrate shown in FIG. 10, in the case where a temperature threshold has been reached or exceeded.

In this example, as shown notably in FIG. 1, the visible surface of the substrate 1 of the device according to this embodiment of the invention comprises a visual indicator 2, in this case comprising a barcode. This visible surface may also include:
a first zone 3 in which the name and the address of the consignee may be displayed in the case where the product on which the substrate 1 is disposed is intended to be shipped;
a second zone 4 in which a description of the function of the device according to this embodiment of the invention and/or information identifying said product is displayed.

The visible surface of the device according to this embodiment may also comprise other information (not shown), such as the barcode, a conventional product allowing the characteristics of the product in question to be identified, information relating to the predetermined temperature threshold(s), publicity information, etc.

More precisely, as shown in FIGS. 3 and 5, the device according to this embodiment of the invention also includes:
a reservoir 5 comprising a component 6 capable of changing form according to the temperature; this component 6 may consist notably in a solid material capable of liquefying when said temperature threshold is reached or exceeded, which component may comprise, for example, a fatty acid or a mixture of fatty acids;
a communication means 7 which may consist in a flow channel linking the reservoir 5 to the visual indicator 2 or, more precisely, to an absorbent layer (not shown) in contact at least partially with the visual indicator 2.

In this way, when the predetermined temperature threshold has been reached or exceeded, the component 6 changes form (in this example it liquefies), which is expressed as a flow movement of the component 6 in the flow channel 7 which directs it toward the absorbent layer in contact with the visual indicator 2.

As shown in FIGS. 4 and 6, the impregnation of the absorbent layer following this flow is expressed as a modification of the appearance of the visual indicator 2, indicating that said temperature threshold has been reached or exceeded. Thus, the form and the disposition of the absorbent layer are designed in such a way as to modify the appearance of the visual indicator 2 when it is impregnated with the liquid.

More precisely, the liquid constituting the component 6 is introduced into parts of this absorbent layer corresponding to certain spacing zones of the vertical lines that make up the barcode 2, thereby modifying its appearance and translating the information according to which the temperature threshold corresponding to said change of form of the component 6 has been reached or exceeded.

According to a different embodiment of the invention, the substrate 1 may comprise a plurality of reservoirs 5, each associated with a visual indicator 2, each being able to comprise a barcode. Each reservoir 5 may thus include a component 6 of which the form change temperature, and more particularly the liquefaction temperature, corresponds to a distinct temperature threshold.

In this way, by means of the device according to this embodiment of the invention, the operator can monitor whether the temperature of the product integrating this device has reached or exceeded a determined number of temperature thresholds.

Advantageously, each of these reservoirs 5 may comprise a component 5 of a different color to render even more visible the information according to which a determined temperature level has been reached or exceeded.

According to a different embodiment of the invention, the substrate 1 may comprise at least one visual indicator 2 comprising a barcode of the aforementioned type and/or a logo, and/or a drawing, and/or written information such as, for example, the phrase “Cold chain preserved: No” (not shown), of which at least one element, i.e. in this case the “No”, is displayed, only following impregnation of an absorbent layer of the aforementioned type, by the liquid comprising the component 6.

In an advantageous manner, said substrate 1, which may consist notably in an identification badge, a label or a card, may include on its lower surface a fixing means (not shown) which may consist in an adhesive tape fitted with a protective film allowing the assembly to be fixed to the product of which the temperature is to be monitored.

Preferably, the substrate 1 of the device according to this embodiment of the invention is used in the following manner:
the substrate 1 is fixed to said product of which the temperature is to be monitored;
the assembly is placed in a refrigerator or cold room, thereby allowing the component capable of changing form 6 to become solid;
the wall of the substrate 1 is pierced by the operator by means of, for example, a needle, at the base of the reservoir 5 in order to allow the component 6 to flow in the case of liquefaction; alternatively, the fixing of the substrate 1 to said product may he carried out following this piercing operation; it may also be envisaged not to fix the substrate 1 to any product, the device according to the invention then allowing the monitoring of the temperature of a room or more generally an enclosed space which may include food products and/or pharmaceutical products;
the component 6 changes form when the temperature threshold is reached or exceeded, producing the effects described above.

According to one embodiment, the substrate 1 may include an activation mechanism (not shown) allowing the operator to perform said piercing of the wall of the substrate 1 dispensing with the use of a needle. This mechanism may, for example, comprise a tongue interworking with a pointed rod included in the substrate, a pulling of this tongue by the operator automatically causing the piercing of said substrate 1.

Advantageously, the liquid comprising the component can be colored in order to render more visible the information according to which the temperature threshold is reached or exceeded.

According to a different embodiment of the invention, the indicator carrying the information according to which the temperature threshold is reached or exceeded may comprise an electronic identification chip in contact with a conducting absorbent layer carrying electric charges following impregnation by the electricity-conducting liquid.

In this way, this electronic chip may be an RFID (Radio Frequency Identification) transponder module of which the information can be read remotely by a transceiver module, thus advantageously allowing determination of whether the temperature threshold (s) has/have been reached or exceeded.

According to a different embodiment of the invention, as shown in FIGS. 7 and 8, the device according to the invention includes a substrate 1 which may comprise:
a component 6′ capable of changing size which may comprise a rod or a bar implemented in a material having the characteristic of expanding when the ambient temperature reaches or exceeds said temperature threshold;
a transmission means 8 which may comprise a lever, the tapering end of which is in contact with said bar or rod 6′, this end being able, for example, to be introduced into a slot present in the component 6′; this lever 8, which extends transversely in relation to the axis of the rod or bar 6′, is rotationally mobile around a rotation axis 9; moreover, its other end is linked to a support piece 10 having in this case the shape of a bar, which extends more or less parallel to said component 6′;
at least one visual indicator 2 preferably consisting in a card having at least two zones 14, 14′ preferably disposed one below the other, and comprising information indicating whether a determined temperature threshold has been reached or exceeded;
a support piece 10 having in this case the shape of a bar which includes at least one support means 11 which may comprise a tab on which the end of the lower surface of the visual indicator 2 is supported;
at least one elastic means 12 such as a spring, compressed against the upper surface of the visual indicator 2;
at least one window 13 included on the visible surface of the substrate 1; this window 13, the size of which is more or less identical to that of each of said zones 14, 14′, allows the operator to visualize a part of the visual indicator 2 comprising one of these zones 14, 14′.

Thus, the expansion of the material comprising the component 2′ under the influence of the temperature variation is expressed as a translation movement of this component 2′ which is transmitted by the transmission means 8 to the support piece 10, this transmission means 8 undergoing a tilting movement around the axis of rotation 9.

As shown in FIG. 8, the support piece 10 in the shape of a bar then undergoes a translation movement which is expressed as a lowering of the visual indicator 2; the latter no longer being supported by the corresponding support means 11, the action of the elastic means 12 causes a translation toward the support piece 10 of the visual indicator 2, thus allowing visualization of the zone 14′ in which the information according to which a temperature threshold has just been reached or exceeded is displayed.

Obviously, the coefficient of expansion of the component 6′ and the positioning of the support means 11 depend on the determined temperature threshold.

According to one embodiment of the invention, as shown in FIG. 9, each visual indicator 2 may include a slot 15 conforming in shape with the corresponding support means 11 in order to allow these support means 11 to be introduced into the slots 15 when the visual indicators 2 go down following the movement of the support piece 10. Moreover, the elastic means 12 may be of the blade spring type, capable of oscillating according to an axis of rotation 16 transverse in relation. to the axis of the component 6′, and the ends of which each interwork with a projecting part 17 extending from the upper side of a visual indicator 2. The assembly is formed in such a way that
only one visual indicator 2 goes down following the movement of the support piece 10, in the case where the substrate 1 comprises two visual indicators 2;
the two visual indicators 2 are capable of indicating to the operator whether the temperature to be monitored lies within a predefined range, these visual indicators 2 being capable of indicating respectively whether a minimum and maximum threshold temperature have been reached or exceeded.

Thus, as shown in FIGS. 10 and 11, the visible surface of the substrate 1 comprises two windows 13, each associated with a temperature threshold, information 19 relating to these temperature thresholds being able to appear close to these windows 13.

These windows 13 enable the visualization of one of the zones 14, 14′ of the visual indicator 2 carrying the information according to which the corresponding temperature threshold has or has not been reached or exceeded.

According to a different embodiment of the invention, each of these zones 14, 14′ of the visual indicator 2 may include vertical bars which are superimposed on a barcode (not shown). Thus, according to the zone 14, 14′ present in the window 13, the barcode will carry different information such as, for example, the temperature threshold has been reached or exceeded in one case, and the temperature threshold has not been reached or exceeded in the other case.

This visible surface of the substrate 1 may also include a zone 18 in which a description of the function of the device according to the invention is displayed.

According to a different embodiment of the invention, the indicator 2 carrying the information according to which the temperature threshold is reached or exceeded, may comprise a flap interworking with a switchable electronic identification chip during the translation of said flap due to the movement of the support piece 10.

In this way, this electronic chip may be an RFID (“Radio Frequency Identification”) transponder module of which the information can be read remotely by a transceiver module, advantageously allowing determination of whether the temperature threshold(s) has/have been reached or exceeded.

1. A device capable of indicating that at least one temperature threshold has been reached and/or exceeded, characterized in that it includes a substrate (1), at least one of the surfaces of which comprises at least one externally visible visual and/or audio indicator (2), said substrate (1) including:
at least one component (6, 6′) capable of changing form and/or size under the influence of temperature; these changes that take place when said at least one temperature threshold is reached or exceeded causing a movement of said component (6, 6′);
at least one transmission (8) or communication (7) means that enables the direct or indirect transmission of said movement of the component (6, 6′) to and/or toward the visual and/or audio indicator (2), said transmission being expressed as:
a change in the appearance of the indicator (2) if the latter is visual; and/or
a release of an audio signal if the indicator (2) is an audio indicator.

2. The device as claimed in claim 1,
characterized in that the visible surface of the substrate (1) comprises a visual indicator (2) comprising a barcode; this visible surface may also include:
a first zone (3) in which the name and the address of the consignee may be displayed in the case where the product on which the substrate (1) is disposed is intended to be shipped;
a second zone (4) in which a description of the function of the device according to this embodiment of the invention and/or information identifying said product is displayed.

3. The device as claimed in claim 1, characterized in that it also includes:
a reservoir (5) comprising a component (6) capable of changing form according to the temperature; this component (6) may consist notably in a solid material capable of liquefying when said temperature threshold is reached or exceeded,
a communication means (7) which may consist in a flow channel linking the reservoir (5) to the visual indicator (2) or, more precisely, to an absorbent layer in contact at least partially with the visual indicator (2);
in this way, when the predetermined temperature threshold has been reached or exceeded, the component (6) changes form, which is expressed as a flow movement of the component (6) in the flow channel (7) which directs it toward the absorbent layer in contact with the visual indicator (2).

4. The device as claimed in claim 3,
characterized in that the impregnation of the absorbent layer following this flow is expressed as a modification of the appearance of the visual indicator (2), indicating that said temperature threshold has been reached or exceeded; and in that the form and the disposition of the absorbent layer are designed in such a way as to modify the appearance of the visual indicator (2) when it is impregnated with the liquid.

5. The device as claimed in claim 4,
characterized in that the liquid comprising the component (6) is introduced into parts of this absorbent layer corresponding to certain spacing zones of the vertical lines that make up the barcode (2), thereby modifying its appearance and translating the information according to which the temperature threshold corresponding to said change of form of the component (6) has been reached or exceeded.

6. The device as claimed in claim 3, characterized in that the substrate (1) comprises a plurality of reservoirs (5), each associated with a visual indicator (2), each being able to comprise a barcode; and in that each reservoir (5) includes a component (6) of which the temperature of a change in form corresponds to a distinct temperature threshold.

7. The device as claimed in claim 3, characterized in that the substrate (1) includes at least one visual indicator (2) comprising a barcode and/or a logo, and/or a drawing, and/or written information, of which at least one element is displayed only following impregnation of an absorbent layer corresponding to this element by the liquid comprising the component (6).

8. The device as claimed in claim 3, characterized in that the liquid comprising the component (6) is colored in order to render more visible the information according to which the temperature threshold is reached or exceeded

9. The device as claimed in claim 3,
characterized in that the indicator carrying the information according to which the temperature threshold is reached or exceeded comprises an electronic identification chip in contact with a conducting absorbent layer carrying electric charges following impregnation by the electricity-conducting liquid; the information carried by this electronic RFID chip being able to be read remotely by a transceiver module, thus allowing determination of whether the temperature threshold(s) has/have been reached or exceeded.

10. The use of the device as defined in claim 4 in order to determine whether at least one temperature threshold has been reached or exceeded, characterized in that:
the substrate (1) is fixed to said product of which the temperature is to be monitored;
the assembly is placed in a refrigerator or cold room, thereby allowing the component capable of changing form (6) to become solid;
the wall of the substrate (1) is pierced by the operator at the base of the reservoir (5) in order to allow the component (6) to flow in the case of liquefaction, wherein the fixing of the substrate (1) to said product may be effected following this piercing operation, and wherein the substrate (1) may also not be fixed to any product;
the component (6) changes form when the temperature threshold is reached or exceeded, producing the effects due to the flow of the liquid.

11. The device as claimed in claim 1,
characterized in that the component (6′) capable of changing size is implemented in a material having the characteristic of expanding when the ambient temperature reaches or exceeds said temperature threshold; and in that the expansion of this material is expressed as a translation movement of said component (6′) which is transmitted by the transmission means (8) to at least one visual indicator (2) which in turn undergoes a translation movement, this translation movement of the visual indicator (2) allowing the presentation of visual information indicating that said temperature threshold has been reached or exceeded.

12. The device as claimed in claim 11,
characterized in that the substrate (1) comprises:
a component (6′) capable of changing size which may comprise a rod or bar made from a material having the characteristic of expanding when the ambient temperature reaches or exceeds said temperature threshold;
a transmission means (8) which may comprise a lever, the tapering end of which is in contact with said bar or rod (6′); this lever (8), which extends transversely in relation to the axis of the rod or bar (6′), is rotationally mobile around a rotation axis (9); moreover, its other end is linked to a support piece (10) which extends more or less parallel to said component (6′);
at least one visual indicator (2) having at least two zones (14, 14′), each comprising information indicating whether a determined temperature threshold has been reached or exceeded;
a support piece (10) which includes at least one support means (11) which may comprise a tab on which the end of the lower surface of the visual indicator (2) is supported;
at least one elastic means (12), such as a spring, compressed against the upper surface of the visual indicator (2);
at least one window (13) included on the visible surface of the substrate (1); this window (13), the size of which is more or less identical to that of each of said zones (14, 14′), allows the operator to visualize a part of the visual indicator (2) comprising one of these zones (14, 14′);
thus, the expansion of the material comprising the component (2′) under the influence of the temperature variation is expressed as a translation movement of this component (2′) which is transmitted by the transmission means (8) to the support piece (10), this transmission means (8) undergoing a tilting movement around the axis of rotation (9); the support piece (10) then undergoes a translation movement which is expressed as a lowering of the visual indicator (2);
the latter no longer being supported by the corresponding support means (11), the action of the elastic means (12) causes a translation toward the support piece (10) of the visual indicator (2), thus allowing visualization of the zone (14′) in which the information according to which a temperature threshold has just been reached or exceeded is displayed.

13. The device as claimed in claim 12,
characterized in that each visual indicator (2) includes a slot (15) conforming in shape with the corresponding support means (11) in order to allow these support means (11) to be introduced into the slots (15) when the visual indicators (2) go down following the movement of the support piece (10); and in that the elastic means (12), which is of the blade spring type, oscillates according to an axis of rotation (16) transverse in relation to the axis of the component (6′), these ends each interworking with a projecting part (17) extending from the upper side of a visual indicator (2); the assembly is formed in such a way that:
only one visual indicator (2) goes down following the movement of the support piece (10), in the case where the substrate (1) comprises two visual indicators (2);
the two visual indicators (2) are capable of indicating to the operator whether the temperature to be monitored lies within a predefined range, these visual indicators (2) being capable of indicating respectively whether a minimum and maximum threshold temperature have been reached or exceeded.

14. The device as claimed in claim 12, characterized in that each of these zones (14, 14′) of the visual indicator (2) includes vertical bars which are superimposed on a barcode; according to the zone (14, 14′) present in the window (13), the barcode carries different information, such as the temperature threshold has been reached or exceeded in one case, and the temperature threshold has not been reached or exceeded in the other case.

15. The device as claimed in claim 11, characterized in that the indicator (2) comprises a flap interworking with a switchable electronic identification chip during the translation of said flap due to the movement of the support piece (10); and in that this electronic chip is an RFID transponder module of which the information can be read remotely by a transceiver module, allowing determination of whether the temperature threshold(s) has/have been reached or exceeded.
